(19) United States
(12) Patent Application Publication
(10) Pub. No.: US 2016/0313957 A1
(43) Pub. Date: Oct. 27, 2016

(54) REAL-TIME EVENT MANAGEMENT

(71) Applicant: Wandr LLC, Minneapolis, MN (US)

(72) Inventors: Jay Matthew Ebert, Fridley, MN (US); Russell David Bunch, Saint Paul, MN (US); Clay Anthony O'Neil, Clear Lake, MN (US)

(21) Appl. No.: 15/133,101

(22) Filed: Apr. 19, 2016

Related U.S. Application Data
(60) Provisional application No. 62/150,573, filed on Apr. 21, 2015.

(51) Int. Cl. G06F 3/14; G06F 3/0481; G06F 3/0482; G09G 5/12; G09G 5/373; H04W 4/02; G06F 3/0484

(52) U.S. Cl. CPC G06F 3/14; H04W 4/02; G06F 3/04817; G06F 3/04845; G09G 5/12; G09G 5/373; G06F 3/0482; G09G 2370/02

(57) ABSTRACT

In one example, a method includes receiving, by a computing device, data for an event having a geographical location, the data including information indicative of a popularity of the event. The method further includes determining, by the computing device and based on the information indicative of the popularity of the event, a popularity score for the event, and outputting, by the computing device, one or more display attributes of an event icon associated with the event that cause the event icon to be displayed on a georeferenced map of a geographical area including the geographical location of the event. At least one of the one or more display attributes corresponds to the determined popularity score for the event.

### CROSS-REFERENCE TO RELATED APPLICATION

This application claims the benefit of U.S. Provisional Application No. 62/150,573, filed Apr. 21, 2015, for “Real-Time Event Management”.

### BACKGROUND

Mobile computing devices, such as cellular telephones (including smartphones), tablet computers, laptop computers, and the like, are often used to send and receive data. For example, mobile computing devices often execute computer-readable instructions in the form of software applications that send and receive data with server devices and/or other mobile computing devices via wired or wireless networks, or both. Increased availability of such mobile computing devices due to, e.g., cost decreases and miniaturization techniques, has led to a proliferation of so-called “social networking” applications that facilitate virtual interactions of users. For instance, members of a social network can often send and receive messages (e.g., textual messages, voice messages, etc.) and share digital media, such as digital photographs, videos, or other media, thereby forming a virtual community through interactions among members.

In some cases, data sharing techniques, such as those utilized by social networking applications, are utilized to organize and/or advertise events. For instance, organizations such as schools, community groups, restaurants, bands, or other organizations often advertise upcoming events (i.e., gatherings of people at a geographical location) via messages among social network members in an effort to gain attendance to the event. Attendance to such events, however, is often limited by factors such as a number of members within the social network or specific virtual community that can receive such advertising messages and an amount of effort set forth by an event organizer to advertise the event. Accordingly, it can be difficult for a potential attendee of an event to estimate, in advance, a number of people that may attend a particular event. As such, it can be difficult for potential attendees, who may be invited to or have knowledge of multiple simultaneous events, to discern which of the events may be more popular, and hence, potentially lead to a greater number of social interactions.

### SUMMARY

In one example, a method includes receiving, by a computing device, data for an event having a geographical location, the data including information indicative of a popularity of the event. The method further includes determining, by the computing device and based on the information indicative of the popularity of the event, a popularity score for the event, and outputting, by the computing device, one or more display attributes of an event icon associated with the event that cause the event icon to be displayed on a georeferenced map of a geographical area including the geographical location of the event. At least one of the one or more display attributes corresponds to the determined popularity score for the event.

In another example, a method includes receiving, by a computing device, data for each of a plurality of events. Each of the plurality of events corresponds to a respective geographical location. The data for each of the plurality of events includes information indicative of a popularity of the respective event. The method further includes determining, by the computing device for each of the plurality of events, a popularity score for each respective event. The popularity score for each respective event is based on the information indicative of the plurality the respective event. The method further includes outputting, by the computing device for each of the plurality of events, one or more display attributes of an event icon associated with the respective event that cause the event icon to be displayed on a georeferenced map of a geographical area including the geographical location of the respective event. At least one of the one or more display attributes of each respective event icon corresponds to the determined popularity score for the respective event.

In another example, a system includes a computing device comprising at least one processor and computer-readable memory. The computer-readable memory is encoded with instructions that, when executed by the at least one processor, cause the computing device to receive data for an event having a geographical location, the data including information indicative of a popularity of the event, and determine, based on the information indicative of the popularity of the event, a popularity score for the event. The computer-readable memory is further encoded with instructions that, when executed by the at least one processor, cause the computing device to output one or more display attributes of an event icon associated with the event that cause the event icon to be displayed on a georeferenced map of a geographical area including the geographical location of the event. At least one of the one or more display attributes corresponds to the determined popularity score for the event.

### BRIEF DESCRIPTION OF THE DRAWINGS

FIG. 1 is a block diagram illustrating an example system that can be used to display, on a georeferenced map, at least one event icon having one or more display attributes corresponding to a popularity score for an associated event.

FIG. 2 is a screenshot of an example user interface including event icons displayed on geographical map and having a display size attribute corresponding to a popularity score for an associated event.

FIG. 3 is a screenshot of the example user interface of FIG. 2 illustrating event icons having a display size corresponding to a changed popularity score for the associated events.

FIG. 4 is a screenshot of the example user interface of FIG. 2 illustrating event icons having the display size attribute and displayed at zoomed-in georeferenced map.

FIG. 5 is a screenshot of the example user interface of FIG. 2 illustrating event icons displayed at a zoomed-out georeferenced map.

FIG. 6 is a screenshot of an example user interface illustrating event icons with an information notification corresponding to events associated with an event group icon.

FIG. 7 is flow diagram illustrating example operations to display an event icon having one or more display attributes that correspond to a determine popularity score for the event.

FIG. 8 is a flow diagram illustrating example operations to output an event group icon based on threshold grouping criteria.

### DETAILED DESCRIPTION

According to techniques of this disclosure, a computing device (e.g., a server device), can determine, based on received data for one or more events, a popularity score indicative of a popularity of each of the events. Such data can include, for example, a number and/or rate of indications of user attendance to the event, a number and/or rate of positive and/or negative feedback indications associated with the event, an amount and/or rate at which comments, photos, videos, or other media corresponding to the event is shared, or other data indicative of a popularity of the event. The server device can cause event icons indicating the location and popularity of each of the events to be displayed on georeferenced maps of user devices, such as mobile computing devices communicating with the server device. Techniques of this disclosure can enable a user to change a display scale (e.g., zoom in and out) on the georeferenced map (e.g., displayed at the user device) while the indications of event popularity are maintained. The server device can cause event icons to be grouped and ungrouped as event popularity and/or display scale changes, thereby providing an uncluttered user interface that enhances usability of the system. In this way, a server device implementing techniques described herein can enable quick and efficient user identification of a location and popularity of multiple, geographically disparate events, thereby facilitating social connections of users through dynamically-informed decisions relating to event popularity.

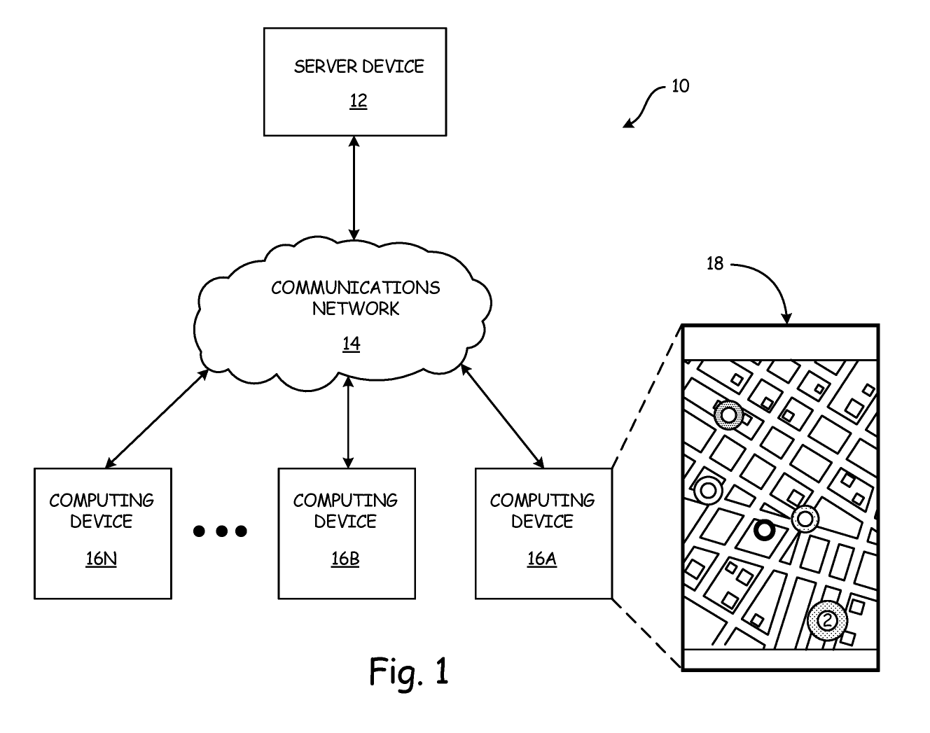

FIG. 1 is a block diagram illustrating an example system 10 that can be used to display, on a georeferenced map, at least one event icon having one or more display attributes corresponding to a popularity score for an associated event. As illustrated in FIG. 1, system 10 can include server device 12, communication network 14, and computing devices 16A-16N (collectively referred to herein as “computing devices 16”). While illustrated in FIG. 1 as including computing devices 16A-16N, computing devices 16 can include any number of computing devices, such that “N” represents an arbitrary number. Similarly, while illustrated with respect to one server device 12, in other examples, system 10 can include multiple server devices, with functionality attributed herein to server device 12 distributed among the multiple server devices.

Examples of computing devices 16 can include, but are not limited to, portable or mobile devices such as mobile phones (including smartphones), laptop computers, tablet computers, personal digital assistants (PDAs), or other portable or non-portable computing devices. Each of computing devices 16 can include, for example, one or more processors, sensors (e.g., accelerometers, global positioning system (GPS) sensors, proximity sensors, or other sensors), input devices (e.g., keyboard, touch-sensitive and/or presence-sensitive display, camera, microphone, or other type of device configured to receive input), communication devices (e.g., wired and/or wireless network interface card, optical transceiver, radio frequency transceiver, or other type of device that can send and receive information), output devices (e.g., a display device, sound card, video graphics card, speaker, liquid crystal display (LCD), or other type of device for outputting information), and/or computer-readable memory.

Processors of computing devices 16, in one example, are configured to implement functionality and/or process instructions for execution within computing devices 16, such as computer-readable instructions stored in computer-readable memory which, when executed by the one or more processors, cause computing devices 16 to operate in accordance with techniques described herein. Examples of one or more processors can include any one or more of a microprocessor, a controller, a digital signal processor (DSP), an application specific integrated circuit (ASIC), a field-programmable gate array (FPGA), or other equivalent discrete or integrated logic circuitry.

Computer-readable memory of computing devices 16 can be configured to store information within computing devices 16 during operation. Computer-readable memory, in some examples, is described as a computer-readable storage medium. In some examples, a computer-readable storage medium can include a non-transitory medium. The term “non-transitory” can indicate that the storage medium is not embodied in a carrier wave or a propagated signal. In certain examples, a non-transitory storage medium can store data that can, over time, change (e.g., in RAM or cache). In some examples, computer-readable memory of computing devices 16 can be a temporary memory, meaning that a primary purpose of the computer-readable memory is not long-term storage. Computer-readable memory of computing devices 16, in some examples, is described as volatile memory, meaning that the computer-readable memory does not maintain stored contents when power to computing devices 16 is turned off. Examples of volatile memories can include random access memories (RAM), dynamic random access memories (DRAM), static random access memories (SRAM), and other forms of volatile memories. In some examples, computer-readable memory is used to store program instructions and/or information for execution by processor(s) of computing devices 16. In some examples, computer readable-memory can include computer-readable storage devices. Computer-readable storage devices can be configured to store larger amounts of information than volatile memory. Storage devices can include, in certain examples, non-volatile storage elements, such as magnetic hard discs, optical discs, flash memories, or forms of electrically programmable memories (EPROM) or electrically erasable and programmable (EEPROM) memories.

Server device 12 can be structurally and/or operatively similar to any one or more of computing devices 16, meaning that server device 12 can include one or more processors, input devices, output devices, communication devices, and/or computer-readable memory that can store information and/or instructions for execution by server device 12. Non-limiting examples of server device 12 can include any one or more of a mainframe computer, server computer, desktop computer, laptop computer, or other such computing device. While described herein as a “server” device, it should be understood that server device 12 can be any device capable of executing computer-readable instructions that cause server device 12 to operate in accordance with techniques described herein. For instance, in some examples, server device 12 can be a mobile computing device, such as a mobile phone (e.g., smartphone), laptop computer, tablet computer, personal digital assistant (PDAs), or other portable computing device. Accordingly, server device 12 is described, in some examples, as a computing device.

Communication network 14 communicatively couples components of system 10. Examples of communication network 14 can include wired or wireless networks or both, such as local area networks (LANs), wireless local area networks (WLANs), cellular networks, wide area networks (WANs) such as the Internet, or other types of networks. Although the example of FIG. 1 is illustrated as including one communication network 14, in certain examples, communication network 14 can include multiple communication networks. In addition, in certain examples, any one or more of computing devices 16 and server device 12 can communicate with one another via point-to-point communications.

Any one or more of computing devices 16 can output, for display at a display device operatively coupled with the respective one of computing devices 16, a georeferenced map of a geographical area including the locations of one or more events. For instance, as illustrated in FIG. 1, computing device 16A can output map 18 of a geographical area including event icons corresponding to locations of events included in the geographical area. While described with respect to map 18 displayed at a display device of computing device 16A, it should be understood that any one or more (e.g., each) of computing devices 16 can similarly output a georeferenced map of a geographical area including locations of events, such as the geographical area of map 18 or a different geographical area.

Computing device 16A can output, at the georeferenced map, event icons associated with each of the one or more events according to display attributes of each event icon received from server device 12. The display attributes can correspond to a popularity score determined by server device 12 based on data received from one or more of computing devices 16 corresponding to the events. Such display attributes, corresponding to the popularity score of each event, can graphically denote an indication of the corresponding popularity score, such as via a display size attribute of the event icon, a display color attribute of the event icon, a display shape attribute of the event icon, or other graphical denotations of an indication of the popularity score.

Computing device 16A, in response to receiving the display attributes of corresponding event icons from server device 12, can output the event icons for display at a georeferenced map according to the received display attributes. Accordingly, server device 12 can be said to execute server-side operations, and computing devices 16 can be said to each execute client-side operations, the server-side operations and client-side operations together forming operations of an application that displays event icons at a georeferenced map according to display attributes corresponding to determined popularity scores for each event. However, while the example operations are described herein as attributed to either server device 12 (i.e., server-side operations) or computing devices 16 (i.e., client-side operations), in some examples, one or more of the described server-side operations can be performed by computing devices 16 and one or more of the described client-side operations can be performed by server device 12. For instance, in some examples, server device 12 outputs display attributes corresponding to event icons, such as a location, size, color, pattern, texture, shading, or other display attributes and computing devices 16 generate the event icon according to the display attributes and display the generated icon. In other examples, server device 12 can generate the event icon having the size, color, pattern, texture, shading, or other display attributes and computing devices 16 can display the received event icon for display at a display device. As another example, server device 12 can output location information of a geographical area and computing devices 16 can display the geographical area on a georeferenced map via a mapping application executing on computing devices 16. In other examples, server device 12 can output the geographical map and computing devices 16 can output the received geographical map for display at the display device.

As one example operation of system 10, a user can initiate an event at a geographical location via a user interface of, e.g., one of computing devices 16, such as computing device 16B (e.g., a smartphone). Event initiation can include input of a location of the event, such as a physical address of the event, via the user interface. In other examples, such as when an event is initiated from the geographical location of the event, the event location can be automatically determined by computing device 16B based on sensed location information via, e.g., GPS sensors of computing device 16B. In some examples, event information, such as a type of event (e.g., food-related event, music-related event, sports-related event, or other type of event), a name of the event, a date of the event, a starting time of the event, an ending time of the event, or other event information can be input via the user interface of computing device 16B. The event data (e.g., the event location, type, date, time, etc.) can be transmitted by computing device 16B to server device 12 via communication network 14.

Server device 12 can store the event data, such as in a database (e.g., a relational database, an object-oriented database, a multi-dimensional database, or one or more other types databases) integral to and/or communicatively coupled with server device 12, thereby associating the event location with the received event data. Thereafter, server device 12 can transmit display attributes associated with the event to those of computing devices 16 that display a geographical map of a geographical area including the event location. That is, one or more of computing devices 16 can display a geographical map, the geographical map corresponding to a geographical area. Computing devices 16 can transmit the displayed geographical area (e.g., boundaries of the geographical area, a reference location within the geographical area along with a display scale, or other information indicative of the displayed geographical area) to server device 12, which can responsively transmit display attribute data associated with event icons corresponding to events having a location with the displayed geographical area. The display attribute data can include one or more attributes corresponding to a determined popularity score (e.g., determined by server device 12) for the event that cause the displayed event icon to graphically indicate the popularity of the event, such as via a display size, color, shape, or other display attributes.

Server device 12 can dynamically determine a popularity score for each of multiple events based on data received from computing devices 16. For example, one or more of computing devices 16 can transmit data to server device 12 associated with an event, such as proximity to the event location (e.g., an indication of user attendance to the event), comments, media, positive feedback indications, negative feedback indications, or other data associated with the event. Server device 12 can determine, based on the received data for the event, a popularity score for the event indicative of a popularity of the event, as is further described below. Server device 12 can dynamically determine (e.g., in real-time) popularity scores for each of the geographically disparate events, and can transmit display attributes of event icons to one or more of computing devices 16 that display a geographical map of a geographical area including the locations of one or more of the events. In this way, server device 12 can enable real-time comparison of the popularity of geographically separate events, thereby enabling user decisions (e.g., attendance decisions) regarding the events based on dynamically-informed data corresponding to the event popularity.

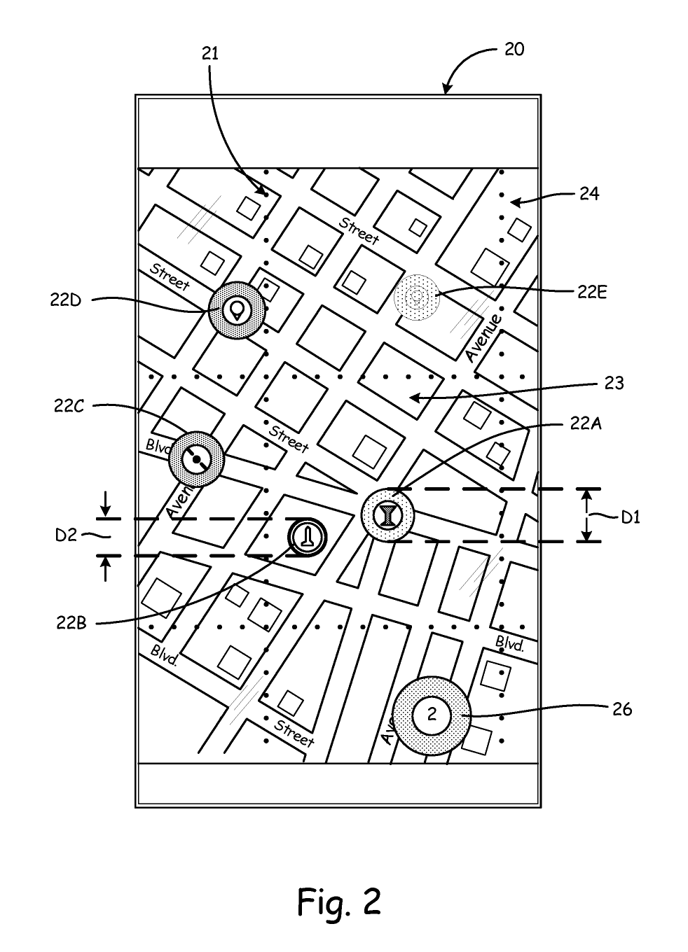

FIG. 2 is a screenshot of an example user interface 20 including event icons 22A-22E (collectively referred to herein as “event icons 22”) displayed on geographical map 24 and having a display size attribute corresponding to a popularity score for an associated event. That is, user interface 20 illustrates an example user interface that can be output by one or more of computing devices 16 (FIG. 1) at a display device operatively coupled to a respective one of computing devices 16 (e.g., integral to or remote from and communicatively coupled with computing devices 16). While the example of FIG. 2 is described for purposes of ease of discussion with respect to computing device 16A of FIG. 1, it should be understood that the techniques described herein are applicable to any one or more of computing devices 16.

As illustrated in FIG. 2, computing device 16A can output geographical map 24 of a geographical area. Geographical map 24 can be a georeferenced map, meaning that indications of locations on geographical map 24 correspond to geographical locations of the geographical area, such as latitude and longitude locations. Computing device 16A can output geographical map 24 according to a geographical scale that correlates a display size of the georeferenced map at the display device and a size of the geographical area. For instance, the geographical scale can correlate a physical length (e.g., one inch) of the display size to a physical length (e.g., one mile) of the geographical area.

Computing device 16A can output, for display, event icons 22 at geographical map 24. Each of event icons 22 corresponds to an event within the geographical area displayed by geographical map 24. In addition, computing device 16A can output event group icon 26 corresponding to multiple events that are physically proximate, as is further described below.

As illustrated in FIG. 2, any one or more of event icons 22 can include an indication of a type of the associated event. For instance, event icon 22A includes an image representative of a martini glass, indicating, e.g., an event type associated with a bar or other such establishment. Similarly, event icon 22C includes an image representative of a compact disc (CD), indicating, e.g., a musical event type (e.g., a live music event, a CD release party, or other such musical event). In addition, each of event icons 22, in the example of FIG. 2, is displayed according to a display size attribute that corresponds to a popularity score for the associated event. For instance, in the example of FIG. 2, a display size of event icons 22 is proportional to the popularity score of the associated event, such that a larger display size correlates to a higher popularity score, and a smaller display size correlates to a lower popularity score for the event. While in the example of FIG. 2, event icons 22 are displayed according to a display size attribute that indicates the corresponding popularity score, in other examples, event icons 22 can be displayed according to other display attributes that indicate the corresponding popularity score, such as a display color (e.g., according to a color spectrum indicating a range of popularity scores), a display shape (e.g., a plurality of shapes indicating a range of popularity scores), a display texture (e.g., a plurality of textures indicating a range of popularity scores), or other such display attributes. In certain examples, event icons 22 can be displayed as including a number associated with the corresponding popularity score, such as a number within a range of numbers that ranges from a least popular score to a most popular score. In general, event icons 22 can be displayed according to any one or more display attributes that graphically indicate relative popularity of events associated with event icons 22.

Computing device 16A, in some examples, can receive the display attributes for each of event icons 22 from server device 12 (FIG. 1). For instance, server device 12 can receive event data for events associated with event icons 22 from one or more of computing devices 16. The event data can include information indicative of the popularity of the event. Example information indicative of the popularity of an event can include, but is not limited to, a number of indications of user attendance to the event (e.g., a number of user check-ins, a number of computing devices 16 within a threshold physical proximity to the location of the event, such as 200 feet, or other indications of user attendance), a rate of the indications of user attendance with respect to time, a number of positive feedback indications associated with the event (e.g., likes, up-votes, or other indications provided via a user interface of computing devices 16), a rate of the positive feedback indications with respect to time, a number of negative feedback indications associated with the event (e.g., dislikes, down-votes, or other indications provided via a user interface of computing devices 16), a rate of the negative feedback indications with respect to time, a number of shared media objects associated with the event (e.g., photographs, videos, or other media), a rate at which the shared media objects are shared with respect to time, a number of shared comments associated with the event (e.g., textual comments, voice comments, or other comments), a rate at which the shared comments are shared with respect to time, a number of indications of planned user attendance, a rate of the indications of planned user attendance with respect to time, a number of users invited to the event, a number of users that have sent invitations to the event, an amount of time elapsed since a starting time of the event, and a length of time spent at the event (e.g., an average length of time per user).

Server device 12 can determine a popularity score associated with an event based on the received data for the event indicative of the popularity of the event. For instance, server device 12 can determine a popularity score as an aggregate (e.g., sum) of sub-scores assigned to each of the categories of the received data for the event (e.g., a comment category, a positive feedback category, a user attendance category, a media sharing category, and the like). In certain examples, server device 12 can apply a weighting factor to the received data for the event, such as a weighting factor determined according to the category of the received data. For instance, server device 12 can apply (e.g., multiply) a user attendance weighting factor to received data categorized as user attendance data, such as by multiplying an aggregate number of user attendance indications by the user attendance weighting factor to determine a contribution of user attendance data to the determined popularity score (i.e., a weighted sub-score). Server device 12 can apply weighting factors to any one or more of the received data, and can determine the popularity score based on the aggregate (e.g., sum) of the weighted data. In certain examples, server device 12 can normalize the determined popularity score, such as to a value ranging between zero and one.

In certain examples, server device 12 can determine the popularity score for an event by determining a popularity increment value based on the information indicative of the popularity of the event and incrementing the popularity score by the popularity increment value. For instance, server device 12 can increment a default popularity score by the determined popularity increment value to determine the popularity score for the event. As another example, server device 12 can increment a previously-determined popularity score for the event by the popularity increment value to determine the popularity score, thereby iteratively modifying the popularity score based on the received event data.

In some examples, server device 12 can determine the popularity score for an event by determining a popularity decrement value based on at least one of an elapsed time since a starting time of the event, a number of negative feedback indications associated with the event, and a rate of the negative feedback indications with respect to time. For instance, as an elapsed time since a starting time of the event increases, the popularity decrement value can increase. Server device 12 can increase the popularity decrement value as the number of negative feedback indications and/or the rate of the negative feedback indications increases. Server device 12 can decrement the popularity score (e.g., a default popularity score or a previously-determined popularity score) by the popularity decrement value to determine the popularity score for the event.

In certain examples, server device 12 can determine the popularity score for the event by adjusting the popularity score using a popularity adjustment value that is determined based on both a popularity increment value and a popularity decrement value. For example, server device 12 can determine the popularity increment value based on the received information indicative of the popularity of the event. Server device 12 can determine the popularity decrement value based on at least one of the information indicative of the popularity of the event and an elapsed time since a starting time of the event. Server device 12 can determine the popularity adjustment value as an aggregate (e.g., sum, weighted sum, average, or other aggregation) of the popularity increment value and the popularity decrement value. Server device 12 can adjust the popularity score (e.g., a default popularity score or a previously-determined popularity score) using the determined popularity adjustment value, such as by adding the adjustment value (or subtracting negative adjustment values) and the default or previously-determined popularity score.

In some examples, server device 12 can decrement the popularity score by the popularity decrement value in response to determining that the corresponding event satisfies threshold atrophy criteria, such as a threshold popularity score, a threshold elapsed time since a start of the event, or other criteria corresponding to the event. The atrophy criteria can be predetermined, or can be determined and/or modified via user input. Server device 12 can refrain from decrementing the popularity score by the popularity decrement value in response to determining that the event does not satisfy the threshold atrophy criteria. For example, server device 12 can compare the determined popularity score for an event to the threshold popularity score, and can determine that the event satisfies the threshold atrophy criteria when the determined popularity score is greater than (or equal to) the threshold popularity score. Similarly, server device 12 can compare an elapsed time since a start of the event to the threshold elapsed time and can determine that the event satisfies the threshold atrophy criteria when the elapsed time is greater than (or equal to) the threshold elapsed time. In certain examples, server device 12 can refrain from determining the popularity decrement value in response to determining that the event does not satisfy the threshold atrophy criteria. By applying the popularity decrement value in response to determining that the event satisfies the threshold atrophy criteria and refraining from determining (or applying) the popularity decrement value until the event satisfies the threshold atrophy criteria, server device 12 can enable the popularity score for the event to grow to a minimum popularity score while helping to ensure that the popularity score does not exceed maximum popularity score criteria.

Server device 12 can determine, based on the determined popularity score for an event, one or more display attributes of event icons 22 that correspond to the determined popularity score. For instance, as in the example of FIG. 2, server device 12 can determine display size attributes of event icons 22 that correspond to the determined popularity score. Server device 12 can transmit the display attributes to computing devices 16, e.g., computing device 16A, to cause computing devices 16 to output event icons 22 for display according to the determined display attributes. As illustrated in FIG. 2, computing device 16A outputs, according to display attributes received from server device 12, event icon 22A having display diameter D1 and event icon 22B having display diameter D2. While described herein with respect to diameters of generally circular event icons 22, in other examples, a display size attribute can indicate other display size parameters, such as a display radius of circular event icons, a display width and/or height of rectangular event icons, a display area of polygonal event icons, or other display size attributes.

As illustrated in FIG. 2, display diameter D1 of event icon 22A is larger than display diameter D2 of event icon 22B, indicating that a determined popularity score corresponding to event icon 22A is greater than a determined popularity score corresponding to event icon 22B. As such, a user viewing geographical map 24 can determine a geographical location and type of multiple events corresponding to event icons 22 within the geographical area displayed at geographical map 24. In addition, the user can efficiently discern that the event corresponding to event icon 22A is likely more popular (i.e., based on a popularity score indicative of a popularity of the event) than the event corresponding to event icon 22B, thereby informing user decisions, such as attendance decisions.

As further illustrated in FIG. 2, server device 12 (FIG. 1) can segregate areas of geographical map 24 into individual cells using grid 21. In FIG. 2, dotted lines of grid 21 indicate boundaries of individual cells within grid 21. Though illustrated in FIG. 2 as dotted lines overlaid on geographical map 24, in some examples, boundaries of grid 21 (i.e., the illustrated dotted lines) may not be graphically rendered. Rather, server device 12 can segregate areas of geographical map 24 into individual cells using grid 21 without outputting the boundaries of cells of grid 21 for display at the display device.

Server device 12 can, in some examples, determine the geographical locations of cell boundaries of grid 21 based on one or more of a population (i.e., human population), population density, or other population-based criteria of the displayed areas of geographical map 24. For instance, server device 12 can determine the geographical locations of cell boundaries of grid 21 such that a population (or population density) included within each individual cell of grid 21 is within a threshold population (or population density) of neighboring cells. In other examples, server device 12 can determine the locations of cell boundaries of grid 21 based on criteria other than population-based criteria, such as a total geographical area included in each of the cells, or other criteria.

Cell boundary locations of grid 21 can coincide, in certain examples, with geographical landmarks, such as streets, neighborhood boundaries, city boundaries, county boundaries, or other geographical landmarks or boundaries. In other examples, such as the illustrated example of FIG. 2, locations of cell boundaries of grid 21 may not coincide with defined geographical landmarks. As illustrated in FIG. 2, a displayed area of geographical map 24 can include more than one cell of grid 21. In other examples, a displayed area of geographical map 24 can include a single cell or a portion of a single cell of grid 21.

As illustrated, server device 12 can determine the locations of cell boundaries of grid 21 to segregate geographical map 24 into individual cells. As in the example of FIG. 2, each of the individual cells can be rectangular and of a same size (i.e., each defined to include a same amount of geographical area). In other examples, any two or more of the individual cells of grid 21 can be of different shapes (e.g., polygonal), and the respective boundaries can be defined such that any two or more of the cells of grid 21 include different amounts of geographical areas.

Server device 12 can determine locations of cell boundaries of grid 21 based on a population of a geographical area that is displayed at geographical map 24 and/or a population of surrounding areas proximate to the geographical area that is displayed at geographical map 24. For instance, in some examples, server device 12 can determine locations of cell boundaries of grid 21 such that each of the individual cells of grid 21 includes a first fixed geographical area within an urban area having a relatively high population density (e.g., greater than a population density threshold) and such that each of the individual cells of grid 21 includes a second (e.g., greater) fixed geographical area within a rural area having a relatively low population density (e.g., less than the population density threshold).

Server device 12 can determine display attributes of event icons displayed at geographical map 24 based on popularity scores and/or display attributes of two or more other event icons (e.g., each event icon, each event icon included within a same event or display category, or any other grouping of two or more event icons) included within a same cell of grid 21. For instance, as illustrated in FIG. 2, each of event icon 22A and event icon 22B are included within the cell boundaries of grid 21 defining cell 23. Server device 12, in some examples, can determine display attributes defining, e.g., a size of each of event icon 22A and event icon 22B based on relative display size criteria for each of event icon 22A and 22B. For instance, server device 12 can determine an average popularity score for cell 23 as the average of the popularity scores of the events associated with event icons 22A and 22B. Server device 12 can determine diameter D1 of event icon 22A based on a deviation of the popularity score associated with event icon 22A from the average popularity score. Similarly, server device 12 can determine diameter D2 of event icon 22B based on a deviation of the popularity score associated with event icon 22B from the average popularity score. As such, server device 12 can determine display attributes for multiple event icons included within a single cell (e.g., cell 23) of grid 21 relative to popularity scores for multiple (e.g., each) of the events associated with event icons within the single cell. In this way, server device 12 can output display attributes (e.g., size attributes) for event icons included within a single cell that graphically differentiate popularity scores for the events while helping to ensure that no display attribute for a single event icon far exceeds (and graphically dominates) the display attributes of other event icons within the same cell of grid 21.

In some examples, server device 12 can determine display attributes for event icons included within a same cell based on popularity scores and/or display attributes of event icons corresponding to a same category and/or subcategory of event. For example, server device 12 can categorize events within grid 21 and/or geographical map 24 based on a type of event determined during initiation of the event by, e.g., a user. Example categories of events can include, but are not limited to, a food and drink category, an entertainment category, a public event category, a special interest category, or other event categories. Subcategories can include, e.g., a happy hour subcategory of a food and drink category, a concert subcategory of an entertain category, an educational class subcategory of a special interest category, or other subcategories. In general, server device 12 can group events according to any defined category and/or subcategory relationship, thereby enabling server device 12 to compare popularity scores and display attributes of corresponding event icons based on the category and/or subcategory relationship.

Server device 12 can, in certain examples, determine display attributes for event icons included in a same cell of grid 21 based on a relative popularity score (e.g., average popularity score) of events within the cell associated with a same category or subcategory of event. As such, server device 12 can determine display attributes for event icons included within a same cell that are based on (e.g., relative to) popularity scores for events associated with a same category or subcategory but independent of popularity scores for events within the cell that are associated with different categories or subcategories.

Server device 12 can determine display attributes for event group icons, such as event group icon 26, based on display attributes of each of the individual event icons associated with the event group icon. For example, server device 12 can determine display size attributes for event icons associated with event group icon 26 and included within the boundaries of the cell that includes event group icon 26. Server device 12 can determine the display size attribute for event group icon 26 based on an average, weighted average, or other central tendency of the individual event icons associated with event group icon 26.

In certain examples, server device 12 can determine a display size attribute of event icons 22 and event group icon 26 based on one or more of a maximum and minimum display size of event icons. The maximum and minimum event icon display size can be determined, in some examples, based on a physical display resolution (i.e., an assumed physical display resolution of a display device that displays the event icons). In other examples, server device 12 can determine the maximum and/or minimum display size based on a logical display resolution, such as a logical display resolution that maps one or more physical pixels of a display device to one logical pixel. Server device 12 can limit, in some examples, a display size attribute of event icons and event group icons to a display size that is less than (or equal to) a maximum event icon display size and event group icon display size, respectively. Server device 12 can limit, in certain examples, the display size attribute of event icons and event group icons to a display size that is greater than (or equal to) a minimum event icon display size and event group icon display size, respectively. In some examples, the maximum and/or minimum event icon display size and event group icon display size can be determined for each cell of grid 21. Event icons and event group icons can have a same or different maximum and minimum display size. Accordingly, server device 12 can help to ensure that display attributes of event icons and event group icons graphically denote relative popularity among the associated events while helping to ensure that a relative sizing of the event icons and event group icons allows each icon to be visually discerned by a user that may be viewing the display device. Moreover, use of logical resolutions for maximum and minimum display sizes can help to ensure, in some examples, that a physical display size of event icons is the same between separate display devices.

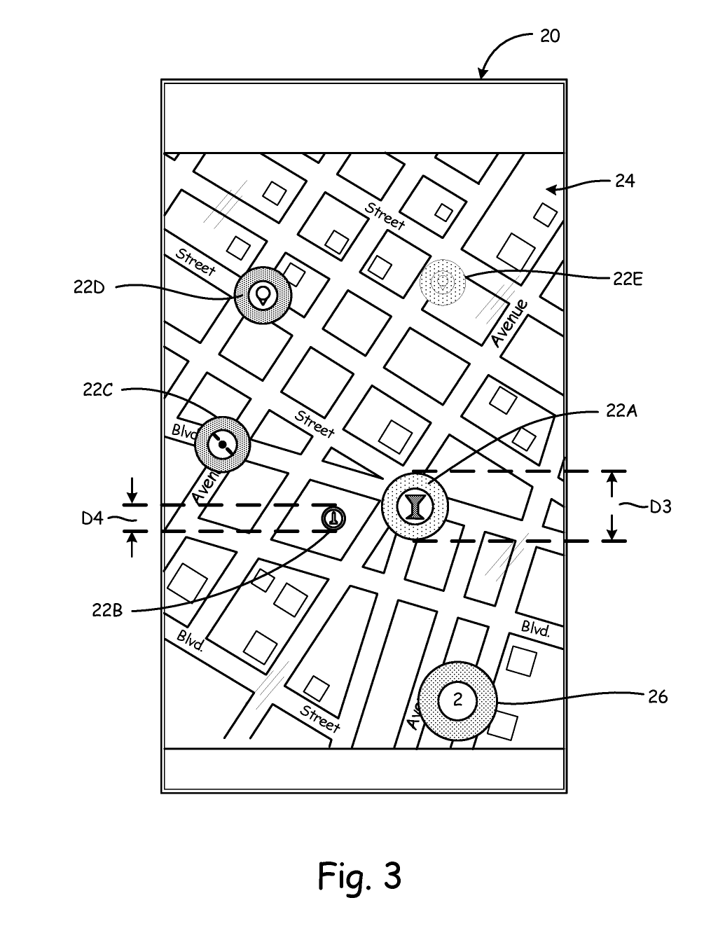

FIG. 3 is a screenshot of the example user interface 20 of FIG. 2 illustrating event icons 22A and 22B, each having a display size corresponding to a changed popularity score for the associated events. That is, FIG. 3 illustrates a screenshot of user interface 20 displaying geographical map 24 with event icons 22 at a different (e.g., later) time than the example of FIG. 2, where server device 12 has determined a different popularity score for each of the events corresponding to event icons 22A and 22B as compared to the determined popularity scores of the example of FIG. 2.

As illustrated in FIG. 3, computing device 16A outputs geographical map 24 having event icons 22 displayed according to display size attributes received from server device 12. In this example, the display size attributes for each of event icons 22C, 22D, and 22E, as well as for event group icon 26, remain unchanged as compared to the corresponding display size attributes of the example of FIG. 2, thereby indicating an unchanged popularity score for each of the associated events.

In the example of FIG. 3, computing device 16A outputs event icon 22A having display diameter D3 and event icon 22B having display diameter D4. As illustrated, display diameter D3 of event icon 22A is greater than display diameter D1 of event icon 22A with respect to the example of FIG. 2, thereby indicating an increased popularity score for the event associated with event icon 22A. Display diameter D4 of event icon 22B is less than display diameter D2 of event icon 22B with respect to the example of FIG. 2, thereby indicating a decreased popularity score for the event associated with event icon 22B. Server device 12 can dynamically determine popularity scores for each of event icons 22, and can output display attributes for event icons 22 corresponding to the determined popularity scores that cause computing device 16A (or any one or more of computing devices 16) to display event icons 22 at geographical map 24 according to the display attributes. In this way, server device 12 and computing devices 16 can provide an indication of both a location and popularity of events, the popularity indications based on dynamically-updated data indicative of the popularity of the event.

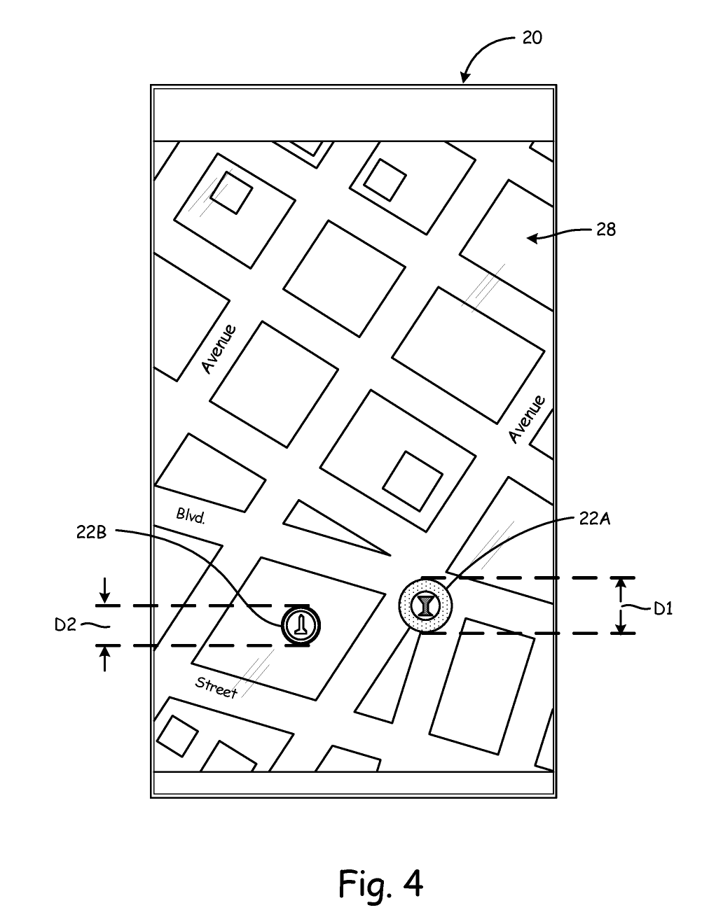

FIG. 4 is a screenshot of the example user interface 20 of FIG. 2 illustrating event icons 22A and 22B having the display size attribute and displayed at a zoomed-in georeferenced map. That is, FIG. 4 illustrates a screenshot of user interface 20 displaying georeferenced map 28 that displays a smaller geographical area than the geographical area displayed with respect to FIG. 2, namely a geographical area that includes locations of events associated with event icons 22A and 22B and that does not include locations of events associated with each of event icons 22C, 22D, and 22E.

Any one or more of computing devices 16, such as computing device 16A, can receive an indication of user input to modify a geographical scale (i.e., a scale that correlates a display size of the georeferenced map and a size of the geographical area) of a displayed georeferenced map. For instance, computing device 16A, via a user interface (e.g., user interface 20), can receive an indication of user input to modify the geographical scale, such as to zoom in (i.e., decrease the displayed geographical area and therefore increase a ratio of the display size of the georeferenced map to the size of the displayed geographical area) or zoom out (i.e., increase the displayed geographical area and therefore decrease a ratio of the display size of the georeferenced map to the size of the displayed geographical area). Examples of such user input can include, but are not limited to, pinch-to-zoom gestures (e.g., at a touch-sensitive and/or presence-sensitive display), virtual and/or hardware button actuation input, or other such indications of user input.

Computing device 16A (or, in some examples, server device 12) can determine a modified geographical scale of the displayed georeferenced map based on the received indication of the user input. Computing device 16A can output the georeferenced map (e.g., georeferenced map 28 in this example) according to the modified geographical scale. For instance, as compared with geographical map 24 of FIG. 2, computing device 16A and/or server device 12 can receive an indication of user input to zoom in, and can display georeferenced map 28 based on a modified geographical scale according to the received indication of the user input.

As further illustrated in FIG. 4, server device 12 can output display size attributes of event icons 22A and 22B such that display icon 22A is displayed having display diameter D1 (i.e., a same display diameter as that of event icon 22A in FIG. 2) and display icon 22B is displayed having display diameter D2 (i.e., a same display diameter as that of event icon 22B in FIG. 2). As such, server device 12 can output display size attributes of event icons 22A and 22B (or any one or more of event icons 22) that cause event icons 22A and 22B to be displayed at the display size corresponding to the determined popularity score for the associated events independent of the modified geographical scale. That is, server device 12 can cause event icons 22A and 22B to be output at a same display size in both the example of FIG. 2 (i.e., on georeferenced map 24 having a first geographical scale) and the example of FIG. 4 (i.e., on georeferenced map 28 having a second geographical scale that is zoomed in with respect to the geographical scale of georeferenced map 24) independent of the displayed geographical scale. Accordingly, server device 12 can maintain the indication of popularity of each of the events associated with event icons 22A and 22B (or any one or more of event icons 22) as a constant indication independent of the scale of the displayed georeferenced map.

In some examples, server device 12 can cause event icons 22A and 22B to be displayed at a same display size in response to determining that a modified geographical scale is included in a current display level of the displayed georeferenced map (e.g., georeferenced map 28 in this example). For instance, server device 12 can determine a plurality of sequential display levels, each of the plurality of sequential display levels including a range of geographical scales, such that a lower bound of the range of geographical scales of each respective one of the plurality of sequential display levels is greater than an upper bound of the range of geographical scales of a sequentially previous one of the plurality of sequential display levels, and an upper bound of the range of geographical scales of each respective one of the plurality of sequential display levels is less than a lower bound of the range of geographical scales of a sequentially next one of the plurality of sequential display levels.

As one example, server device 12 can determine a plurality of sequential display levels for georeferenced map 28, such as three sequential display levels denoted in this example as display level one, display level two, and display level three, although in other examples server device 12 can determine more than three or fewer than three sequential display levels. In such an example, display levels one, two, and three can be considered sequential display levels, such that display level two is considered a sequentially next display level as compared to display level one and a sequentially previous display level as compared to display level three. Similarly, display level one can be considered a sequentially previous display level as compared to display level two, and display level three can be considered a sequentially next display level as compared to display level two.

In such an example, server device 12 can determine display level one as including a range of display scales corresponding to a most zoomed display scale (i.e., a largest ratio of the display size of georeferenced map 28 to the size of the displayed geographical area) to a display scale corresponding to an upper bound for display level one (i.e., a display scale corresponding to a smaller ratio of display size to the size of the displayed geographical area as compared to the most zoomed display scale). Server device 12 can determine display level two as including a range of display scales ranging from a minimum display scale for display level two that is greater than the maximum display scale of display level one to a maximum display scale for display level two. Server device 12 can determine display level three as including a range of display scales ranging from a minimum display scale for display level three that is greater than the maximum display scale of display level two to a maximum display scale for display level three.

Server device 12 can determine a current display level as one of the display plurality of display levels (e.g., one of display level one, display level two, or display level three in this example) that includes the displayed geographical scale. For instance, server device 12 can determine a current display level of georeferenced map 28 as display level one. Server device 12 can determine a display level that includes the modified display scale (i.e., the modified display scale based on the received user input to modify the display scale). For instance, server device 12 can determine a display level that includes the modified display scale as display level one. In such an example, server device 12 can output the display attributes of event icons 22A and 22B to cause event icons 22A and 22B to be displayed at the display diameter (a same display diameter, for example, display diameters D1 and D2) in response to determining that the modified geographical scale is included in the current display level (e.g., display level one in this example). In other examples, server device 12 can output the display attributes of event icons 22A and 22B to cause event icons 22A and 22B to be displayed at modified display diameters (e.g., different than diameters D1 and D2) in response to determining that the modified geographical scale is included in a different display level than the current display level (e.g., one of display levels two or three in this example). In this way, server device 12 can maintain the display size of event icons 22 corresponding to the determined popularity score for each event when a display scale changes within a display level, but can change the display size of event icons 22 when a display scale changes to a different display level.

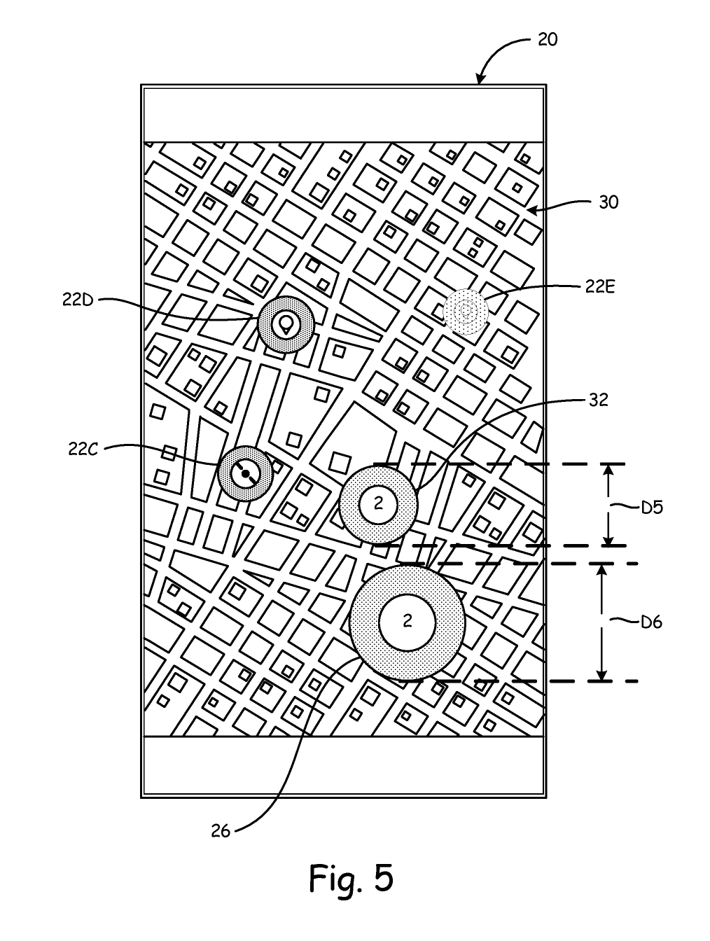

FIG. 5 is a screenshot of the example user interface 20 of FIG. 2 illustrating event icons 22 displayed at a zoomed-out georeferenced map. That is, FIG. 5 illustrates a screenshot of user interface 20 displaying georeferenced map 30 that displays a larger geographical area than the geographical area displayed with respect to FIG. 2.

As illustrated in FIG. 5, computing device 16A outputs event icons 22C, 22D, and 22E for display at georeferenced map 30. In addition, computing device 16A outputs event group icon 26 and event group icon 32 for display at georeferenced map 30. In the example of FIG. 5, server device 12 outputs display attributes for each of event icons 22A and 22B (FIG. 2) that cause event icons 22A and 22B to be displayed as event group icon 32.

As illustrated by the number two within event group icons 26 and 32, each of event group icons 26 and 32 corresponds to two member events, though it should be appreciated that in other examples, group icons 26 and 32 can indicate any number of member events, such as three or more member events. In yet other examples, event group icons 26 and 32 may not include an indication of the number of member events corresponding to the respective event group icon.

Server device 12 can determine that two or more of a plurality of events within a displayed geographical area satisfy threshold grouping criteria, and can responsively output display attributes that cause event icons corresponding to the two or more events to be displayed as a single event group icon. For instance, as in the example of FIG. 5, server device 12 can determine that event icons 22A and 22B (FIG. 4) satisfy threshold grouping criteria. In response, server device 12 can output display attributes for event icons 22A and 22B that cause event icons 22A and 22B to be displayed as event group icon 32 corresponding to member event icons 22A and 22B. The threshold grouping criteria can include, for example, threshold proximity criteria of each of the two or more events, threshold display proximity criteria of each of the associated two or more event icons, or other grouping criteria. As one example, server device 12 can determine that event icons 22A and 22B should be displayed as event group icon 32 based on determining that locations of events associated with event icons 22A and 22B are within a threshold distance, such as one hundred feet, two hundred feet, five hundred feet, or other threshold distances. As another example, server device 12 can determine that event icons 22A and 22B should be displayed as event group icon 32 based on determining that a display distance between event icons 22A and 22B (i.e., a distance between event icons as displayed on a display device) is within a threshold display distance, such as zero inches (e.g., touching and/or overlapping), one-eighth of an inch, one-fourth of an inch, a threshold number of pixels, or other threshold display distances.

Server device 12 can dynamically group and ungroup individual event icons to form event group icons and disassociate event group icons into individual event icons. For example, as a popularity score (and the corresponding display size) for individual events increases, server device 12 can determine that a display distance between the corresponding event icons satisfies the threshold grouping criteria. In response, server device 12 can output display attributes for the corresponding event icons that cause the event icons to be displayed as an event group icon (i.e., rather than the individual event icons). Conversely, as a popularity score (and the corresponding display size) for individual events represented by an event group icon (i.e., member events) decreases, server device 12 can determine that the member events of the event group icon no longer satisfy the threshold grouping criteria. In response, server device 12 can output display attributes for the corresponding event icons that cause the event icons to be displayed as individual event icons rather than the event group icon. As another example, server device 12 can determine, based on a modified geographical scale of a displayed georeferenced map (e.g., georeferenced map 30), that two or more events within the geographical area displayed at the georeferenced map either satisfy or fail to satisfy threshold grouping criteria (e.g., display distance criteria). In response, server device 12 can cause the corresponding event group icons to be displayed as an event group icon (e.g., when the events satisfy the threshold grouping criteria) or as individual event icons (e.g., when the events do not satisfy the threshold grouping criteria).

In some examples, such as the example of FIG. 5, server device 12 can determine a display size attribute of event group icons (e.g., event group icons 26 and 32) corresponding to an aggregate (e.g., sum, average, weighted average, or other aggregate) of a popularity score for each of the member events of the event group icon. For instance, as illustrated in FIG. 5, server device 12 can output event group icon 32 having display diameter D5 that is less than display diameter D6 of event group icon 26. The display diameter of each of the event group icons can correlate to the aggregate of popularity scores of member events of the respective event group icon, such as by being proportional to the aggregate of the respective popularity score. For instance, server device 12 can determine an aggregate (e.g., sum) of the popularity scores for events associated with event icons 22A and 22B (i.e., member events of event icon 32 in this example), and can determine display diameter D5 of event group icon 32 based on the determined aggregate value. Similarly, server device 12 can determine an aggregate (e.g., average) of popularity scores of member events of event group icon 26, and can determine display diameter D6 of event group icon 26 based on the determined aggregate value.

As illustrated, display diameter D6 of event group icon 26, which is larger than display diameter D5 of event group icon 25, can indicate that the aggregate of the popularity scores of events represented by event group icon 26 is greater than the aggregate of the popularity scores of events represented by event group icon 32 (e.g., events associated with event icons 22A and 22B). As such, server device 12 can determine display size attributes of event group icons that correspond to and graphically indicate an aggregate of the popularity of member events, thereby enabling quick and efficient user identification of most popular events within a geographical location.

In some examples, server device 12 can determine that two or more event icons should be displayed as an event group icon (or that an event icon should be displayed as individual event icons) in response to determining that a modified geographical scale of a georeferenced map (e.g., georeferenced map 30) is not included in a current display level. That is, as described above, server device 12 can determine a plurality of display levels, each including a range of geographical scales. Server device 12 (or computing devices 16) can receive an indication of user input to modify a geographical scale of georeferenced map 30, and can determine a modified geographical scale of georeferenced map 30 based on the received indication of user input. Server device 12, in certain examples, can cause event icons to be grouped and/or ungrouped into event group icons in response to determining that the modified geographical scale is not included in a current display level, thereby forming and disassociating event group icons only when georeferenced map 30 transitions between display levels.

Accordingly, server device 12 can dynamically determine whether individual events should be displayed using event group icons representing multiple individual events, or whether each of the events should be displayed using individual event icons. As such, server device 12 can provide an uncluttered interface (e.g., user interface 20) that graphically indicates both a location and a popularity of multiple events on a georeferenced map, thereby enhancing usability of the interface to enable efficient user decisions (e.g., attendance decisions) regarding multiple (e.g., simultaneous) geographically disparate events.

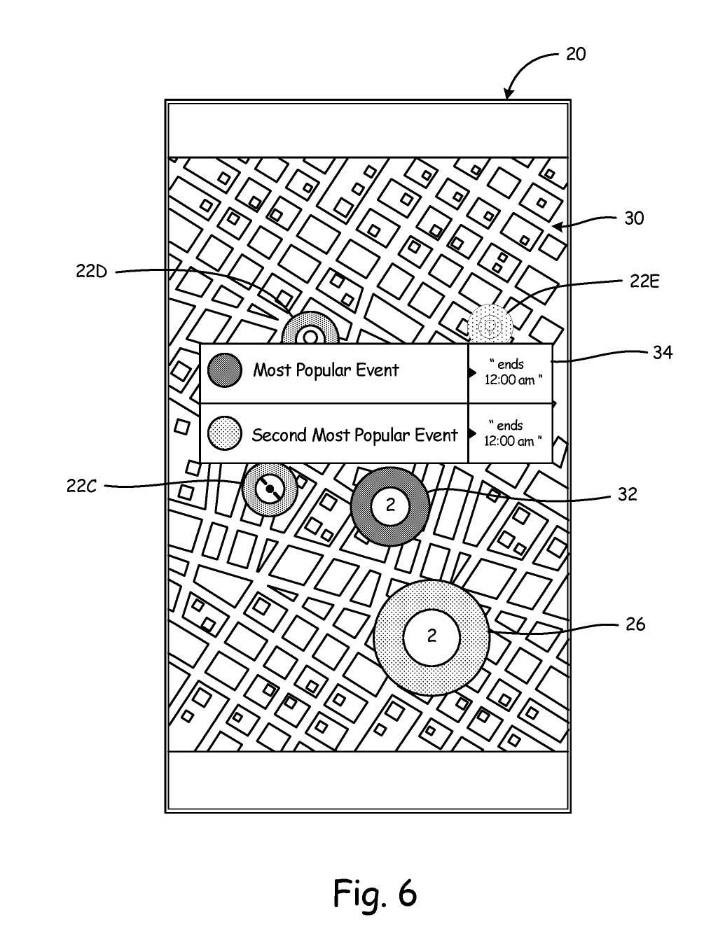

FIG. 6 is a screenshot of the example user interface 20 of FIG. 5 illustrating event icons 22 and information notification 34 corresponding to events associated with event group icon 32. While the example of FIG. 6 is described with respect to a single information notification 34, in other examples user interface 20 can include information notifications for any one or more of event icons 22 and event group icons 26 and 32.

Computing device 16A (or any one or more of computing devices 16) can output information notification 34 in response to, e.g., an indication of user input to select event group icon, such as an indication of a touch gesture (e.g., at a touch-sensitive and/or presence-sensitive display device) to select event group icon 32. Information notification 34 can include information associated with any one or more (e.g., each) of the events represented by event group icon 32. For instance, as illustrated in FIG. 6, information notification 34 can include information identifying events in an ordered list according to popularity scores of the associated events and information corresponding to an end time of the event. In other examples, information notification 34 can include information such as a name of each event, a type of each event, a start time of each event, a featured comment and/or shared media object for each event, a popularity score for each event, or other information associated with each event. In some examples, each of the identified events within information notification 34 can be user selectable, such as via touch input selection. In certain examples, server device 12 and/or computing device 16A can output further information associated with a selected event in response to received user input to select the event, such as by displaying an event page or other information associated with the event. In this way, server device 12 and/or computing devices 16 can enable user identification of individual events represented by an event group icon, as well as detailed information associated with each event.

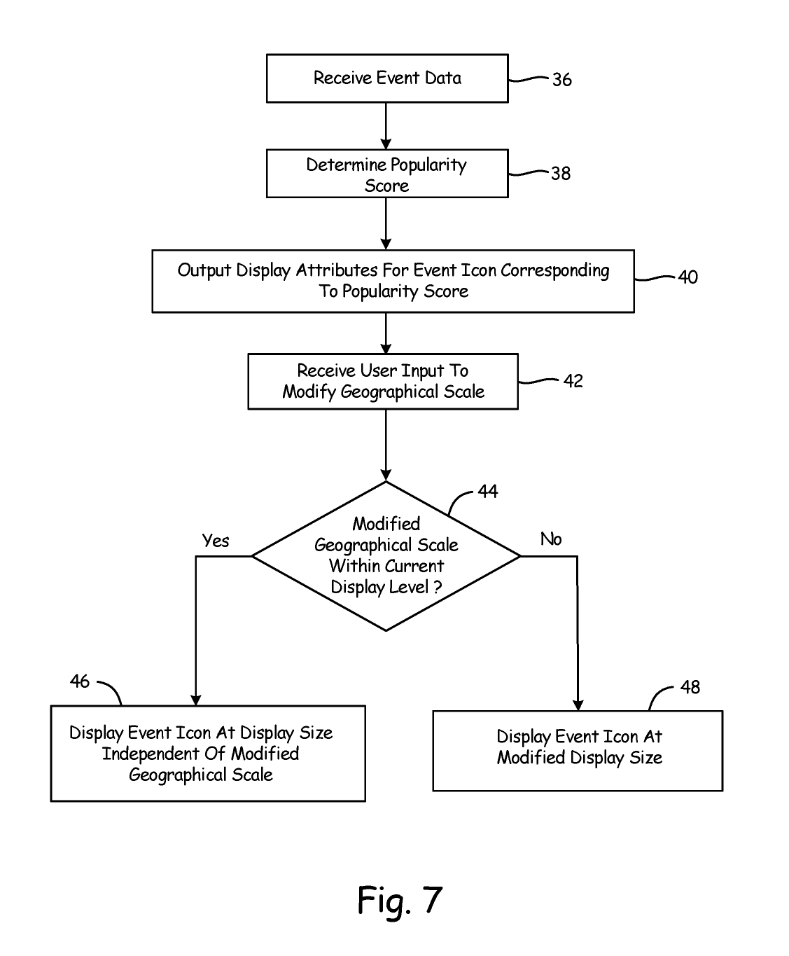

FIG. 7 is flow diagram illustrating example operations to display an event icon having one or more display attributes that correspond to a determine popularity score for the event. For purposes of clarity and ease of discussion, the example operations are described below with respect to system 10 of FIG. 1.

Event data for an event having a geographical location can be received (36). For example, server device 12 can receive data corresponding to an event from one or more of computing devices 16. The event data can include, e.g., a location of the event, a starting time of the event, an ending time of the event, a type of the event, a name of the event, a number of indications of user attendance to the event, a rate of the number of indications of user attendance to the event, a number of positive feedback indications associated with the event, a rate of the positive feedback indications with respect to time, a number of negative feedback indications associated with the event, a rate of the negative feedback indications with respect to time, a number of shared media objects associated with the event, a rate at which the shared media objects are shared with respect to time, a number of shared comments associated with the event, a rate at which the shared comments are shared with respect to time, a number of indications of planned user attendance, a rate of the indications of planned user attendance with respect to time, a number of users invited to the event, a number of users that have sent invitations to the event, an amount of time elapsed since a starting time of the event, and a length of time spent at the event (e.g., an average length of time per user). A portion of the event data can be received from each of a plurality of computing devices 16 via communication network 14. Each portion of the event data can include information indicative of the popularity of the event.

A popularity score for the event can be determined based on the received event data (38). For example, server device 12 can determine a popularity score for the event by determining a popularity increment value based on the information indicative of the popularity of the event and incrementing the popularity score by the popularity increment value. In some examples, server device 12 can determine the popularity score by determining a popularity decrement value for the event and decrementing the popularity score by the popularity decrement value. In certain examples, server device 12 can decrement the popularity score by the popularity decrement value in response to determining that the event satisfies threshold atrophy criteria and can refrain from decrementing the popularity score by the popularity decrement value in response to determining that the event does not satisfy the threshold atrophy criteria. In some examples, server device 12 can determine the popularity decrement value for the event based on at least one of an elapsed time since a starting time of the event, a number of negative feedback indications associated with the event, and a rate of the negative feedback indications with respect to time. In certain examples, server device 12 can determine a popularity increment value based on the information indicative of the popularity of the event and a popularity decrement value based on at least one of the information indicative of the popularity of the event and an elapsed time since a starting time of the event. In such examples, server device 12 can determine a popularity adjustment value as an aggregate of the popularity increment value and the popularity decrement value, and can adjust the popularity score using the determined popularity adjustment value.

One or more display attributes of an event icon associated with the event can be outputted (40). The one or more display attributes of the event icon can cause the event icon to be displayed on a georeferenced map of a geographical area including the location of the event. At least one of the one or more display attributes can correspond to the determined popularity score for the event. For example, server device 12 can output a display size attribute, a display color attribute, a display shape attribute, a display shading attribute, a display texture attribute, or other attribute that is capable of graphically denoting an indication of the determined popularity score for the event. For instance, server device 12 can output a display size attribute for event icon 22A (FIG. 2) causing event icon 22A to be displayed having display diameter D1 at georeferenced map 24 (FIG. 2). The display size attribute can be indicative of the determined popularity score, such as by being proportional to the determined popularity score. In some examples, the one or more display attributes of the event icon can be determined based on one or more other event icons included within the boundaries of a same cell of a grid that segregates portions of the geographical map into separate cells. For instance, as described above with respect to FIG. 2, server device 12 can determine grid 21 that segregates portions of geographical map 24 into separate cells. Server device 12, as described above with respect to FIG. 2, can determine the one or more display attributes of event icons 22 based on display attributes of other event icons included within a same cell of grid 21.

An indication of user input can be received to modify a geographical scale of the georeferenced map that correlates a display size of the georeferenced map and a size of the geographical area (42). For instance, computing device 16A can receive an indication of gesture input (e.g., a pinch-to-zoom gesture received at a touch-sensitive and/or presence-sensitive display device) to modify the geographical scale of the displayed georeferenced map.

It can be determined whether the modified geographical scale is included in a current display level (44). For example, server device 12 and/or one or more of computing devices 16 can determine a plurality of sequential display levels. Each of the plurality of sequential display levels can include a range of geographical scales that correlate a display size of the georeferenced map at the display device and a size of the displayed geographical area. Server device 12 and/or computing devices 16 can determine a current display level as one of the plurality of sequential display levels that includes the displayed geographical scale. Server device 12 and/or computing devices 16 can determine a modified geographical scale of the displayed georeferenced map based on the received indication of the user input to modify the displayed geographical scale. Server device 12 and/or computing devices 16 can determine whether the modified geographical scale is included in the current display level. In some embodiments, however, the example operations may not include operation 44.

In examples where the modified geographical scale is included in the current display level (“YES” branch of 44), server device 12 and/or computing devices 16 can cause the event icon to be displayed at the display size corresponding to the determined popularity score independent of the modified geographical scale (46). In this way, the display attributes (e.g., display size) indicative of the popularity score can be maintained independent of user input to modify a geographical scale (e.g., zoom in or out on the georeferenced map).

In examples where the modified geographical scale is not included in the current display level (“NO” branch of 44), server device 12 and/or computing devices 16 can cause the event icon to be displayed at a modified display size (48). In some examples, server device 12 and/or computing devices 16 may not modify the display size of the event icon when the modified geographical scale is not included in the current display level, but rather may maintain the display size as the previously-displayed size.

In this way, server device 12 and computing devices 16 can cause an event icon to be displayed at a display device, the event icon indicating both a location (e.g., a georeferenced location) and a popularity of the event. As such, the example operations can enable efficient user decisions, such as attendance decisions, to an event based on dynamically-retrieved (e.g., real-time) data indicative of a popularity of the event.

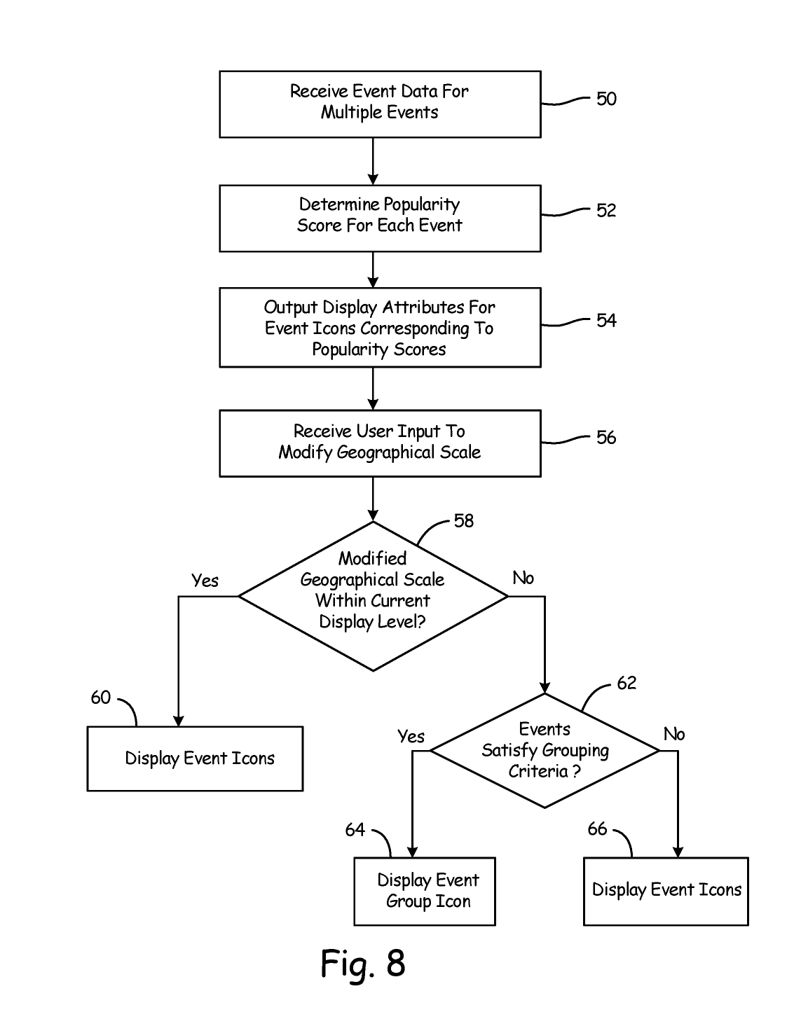

FIG. 8 is a flow diagram illustrating example operations to output an event group icon based on threshold grouping criteria. For purposes of clarity and ease of discussion, the example operations are described below within the context of system 10 of FIG. 1.

Data for each of a plurality of events having respective geographical locations can be received (50). For instance, server device 12 can receive event data for a plurality of events from any one or more of computing devices 16. Each of the plurality of events can correspond to a different geographical location. The data for each of the plurality of events can include information indicative of the popularity of the respective event.

A popularity score can be determined for each of the plurality of events (52). For example, server device 12 can determine, based on the received event data for each of the plurality of events, a popularity score corresponding to each respective event. One or more display attributes of an event icon can be outputted for each respective one of the plurality of events (54). The one or more display attributes can cause each respective event icon to be displayed at a georeferenced map. At least one of the one or more display attributes can correspond to the determined popularity score for the respective event. The one or more display attributes, as described above with respect to FIG. 2, can be determined based on display attributes of two or more event icons included within a same cell of, e.g., grid 21.

User input can be received to modify a geographical scale of the displayed georeferenced map (56). For example, server device 12 and/or computing devices 16 can receive user input to modify the displayed geographical scale, such as to zoom in or out on the georeferenced map to change an amount of a geographical area that is displayed by the georeferenced map.

It can be determined whether a modified geographical scale is included in a current display level of the displayed georeferenced map (58). For example, server device 12 and/or computing devices 16 can determine a modified geographical scale based on the received user input, and can determine whether the modified geographical scale is included within a range of geographical scales of a current display level (i.e., a display level of a plurality of sequential display levels that each includes a plurality of geographical scales). In examples where the modified geographical scale is included in the current display level (“YES” branch of 58), the event icons can be displayed having the at least one display attribute that corresponds to the determined popularity score for each of the plurality of events, such as a display size attribute (60). In examples where the modified geographical scale is not included in the current display level (“NO” branch of 58), server device 12 and/or computing devices 16 can determine whether two or more of the plurality of events satisfy threshold grouping criteria, such as threshold geographical proximity or display proximity criteria (62). Though the example operations of FIG. 8 are described as including operation 58 to determine whether the modified geographical scale is included in the current display level, in other examples, the operations may not include operation 58. That is, in some examples, server device 12 and/or computing devices 16 may determine whether two or more of the events satisfy the threshold grouping criteria (i.e., operation 62) without first determining whether the modified geographical scale is within the current display level.

In examples where two or more of the plurality of events satisfy the threshold grouping criteria (“YES” branch of 62), server device 12 can output display attributes of display icons associated with the two or more of the events that cause the display icons of associated with the two or more of the events to be displayed as an event group icon (64). In examples where the two or more of the plurality of events do not satisfy the threshold grouping criteria (“NO” branch of 62), server device 12 can output display attributes of event icons associated with each of the plurality of events that cause the event icons to be displayed as individual event icons (66).

Accordingly techniques of this disclosure can enable a computing device (e.g., server device 12) to determine, based on received data for one or more events, a popularity score indicative of a popularity of each of the events. Server device 12 can cause event icons indicating the location and popularity of each of the events to be displayed on georeferenced maps of user devices (e.g., any one or more of computing devices 16). The techniques can enable a user to change a display scale (e.g., zoom in and out) on a georeferenced map while the indications of event popularity are maintained, and can enable event icons to be grouped and ungrouped as event popularity and/or display scale changes, thereby providing an uncluttered user interface that enhances usability of the system. In this way, server device 12 and computing devices 16 implementing techniques described herein can enable quick and efficient user identification of a location and popularity of multiple, geographically disparate events, thereby facilitating social connections of users through dynamically-informed decisions relating to event popularity.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A method comprising:
receiving, by a computing device, data for an event having a geographical location, the data including information indicative of a popularity of the event;
determining, by the computing device and based on the information indicative of the popularity of the event, a popularity score for the event; and
outputting, by the computing device, one or more display attributes of an event icon associated with the event that cause the event icon to be displayed on a georeferenced map of a geographical area including the geographical location of the event, at least one of the one or more display attributes corresponding to the determined popularity score for the event.

2. The method of claim 1, wherein the at least one of the one or more display attributes of the event icon corresponding to the determined popularity score comprises a display size of the event icon corresponding to the determined popularity score.

3. The method of claim 2, wherein the display size of the event icon corresponding to the determined popularity score comprises a display size of the event icon that is proportional to the determined popularity score.

4. The method of claim 1, wherein the received data for the event reflects data for the event received from a plurality of remote computing devices via one or more communication networks.

5. The method of claim 1, wherein determining the popularity score for the event comprises:
determining a popularity increment value based on the information indicative of the popularity of the event; and
incrementing the popularity score by the popularity increment value.

6. The method of claim 5, wherein determining the popularity increment value based on the information indicative of the popularity of the event comprises determining the popularity increment value based on at least one of a number of indications of user attendance to the event, a rate of the indications of user attendance with respect to time, a number of positive feedback indications associated with the event, a rate of the positive feedback indications with respect to time, a number of negative feedback indications associated with the event, a rate of the negative feedback indications with respect to time, a number of shared media objects associated with the event, a rate at which the shared media objects are shared with respect to time, a number of shared comments associated with the event, and a rate at which the shared comments are shared with respect to time.

7. The method of claim 1, wherein determining the popularity score for the event comprises:
determining a popularity decrement value for the event; and
decrementing the popularity score by the popularity decrement value.

8. The method of claim 7,
wherein decrementing the popularity score by the popularity decrement value comprises decrementing the popularity score by the popularity decrement value in response to determining that the event satisfies threshold atrophy criteria and refraining from decrementing the popularity score by the popularity decrement value in response to determining that the event does not satisfy the threshold atrophy criteria.

9. The method of claim 7, wherein determining the popularity decrement value for the event comprises determining the popularity decrement value based on at least one of an elapsed time since a starting time of the event, a number of negative feedback indications associated with the event, and a rate of the negative feedback indications with respect to time.

10. The method of claim 1, wherein determining the popularity score for the event comprises:
determining a popularity increment value based on the information indicative of the popularity of the event;
determining a popularity decrement value based on at least one of the information indicative of the popularity of the event and an elapsed time since a starting time of the event;
determining a popularity adjustment value as an aggregate of the popularity increment value and the popularity decrement value; and
adjusting the popularity score using the determined popularity adjustment value.

11. The method of claim 1, wherein the at least one of the one or more display attributes of the event icon corresponding to the determined popularity score comprises a display size of the event icon corresponding to the determined popularity score, wherein the displayed georeferenced map of the geographical area is displayed according to a geographical scale that correlates a display size of the georeferenced map and a size of the geographical area, the method further comprising:
receiving an indication of user input to modify the geographical scale of the displayed georeferenced map;
determining, based on the received indication of the user input to modify the geographical scale, a modified geographical scale of the displayed georeferenced map; and
displaying the georeferenced map of the geographical area according to the modified geographical scale;
wherein outputting the data that causes the event icon to be displayed on the georeferenced map comprises outputting the data that causes the event icon to be displayed at the display size corresponding to the determined popularity score independent of the modified geographical scale.

12. The method of claim 1, wherein the at least one of the one or more display attributes of the event icon corresponding to the determined popularity score comprises a display size of the event icon corresponding to the determined popularity score, wherein the displayed georeferenced map of the geographical area is displayed according to a displayed geographical scale that correlates a display size of the georeferenced map at the display device and a size of the geographical area, the method further comprising:
determining a plurality of sequential display levels, each of the plurality of sequential display levels including a range of geographical scales, wherein a lower bound of the range of geographical scales of each respective one of the plurality of sequential display levels is greater than an upper bound of the range of geographical scales of a sequentially previous one of the plurality of sequential display levels, and wherein an upper bound of the range of geographical scales of each respective one of the plurality of sequential display levels is less than a lower bound of the range of geographical scales of a sequentially next one of the plurality of sequential display levels;
determining a current display level as one of the plurality of sequential display levels that includes the displayed geographical scale;
receiving an indication of user input to modify the displayed geographical scale of the displayed georeferenced map; and
determining, based on the received indication of the user input to modify the displayed geographical scale, a modified geographical scale of the displayed georeferenced map;
wherein outputting the data that causes the event icon to be displayed on the georeferenced map comprises outputting the data that causes the event icon to be displayed at the display size corresponding to the determined popularity score independent of the modified geographical scale in response to determining that the modified geographical scale is included in the current display level.

13. The method of claim 1, wherein the one or more display attributes of the event icon comprises an event type attribute.

14. A method comprising:
receiving, by a computing device, data for each of a plurality of events, wherein each of the plurality of events corresponds to a respective geographical location, and wherein the data for each of the plurality of events includes information indicative of a popularity of the respective event;
determining, by the computing device for each of the plurality of events, a popularity score for each respective event, the popularity score for each respective event based on the information indicative of the plurality the respective event; and
outputting, by the computing device for each of the plurality of events, one or more display attributes of an event icon associated with the respective event that cause the event icon to be displayed on a georeferenced map of a geographical area including the geographical location of the respective event, at least one of the one or more display attributes of each respective event icon corresponding to the determined popularity score for the respective event.

15. The method of claim 14, wherein the at least one of the one or more display attributes of each respective event icon corresponding to the determined popularity score for the respective event comprises a display size of the respective event icon corresponding to the determined popularity score for the respective event.

16. The method of claim 14, further comprising:
segregating, by the computing device, the geographical area including the geographical location of each respective event into a grid comprising a plurality of cells;
determining, by the computing device, two or more of the plurality of events that are included within a same one of the plurality of cells; and
determining, by the computing device, the at least one of the one or more display attributes corresponding to the determined popularity score for the two or more of the plurality of events that are included within the same one of the plurality of cells based on the popularity score of each of the two or more of the plurality of events that are included within the same one of the plurality of cells.

17. The method of claim 14, further comprising:
determining that two or more of the plurality of events satisfy threshold grouping criteria;
wherein outputting the one or more display attributes of each respective event icon associated with the respective event that cause the respective event icon to be displayed on the georeferenced map comprises outputting the one or more display attributes of each of the event icons associated with the two or more of the plurality of events that satisfy the threshold grouping criteria that cause the two or more of the plurality of events that satisfy the threshold grouping criteria to be displayed on the georeferenced map as an event group icon.

18. The method of claim 17,
wherein a display size of the event group icon is based on an aggregate of popularity scores for each of the two or more of the plurality of events that satisfy threshold physical proximity criteria.

19. The method of claim 16, wherein the displayed georeferenced map of the geographical area is displayed according to a displayed geographical scale that correlates a display size of the georeferenced map at a display device and a size of the geographical area, the method further comprising:
determining a plurality of sequential display levels, each of the plurality of sequential display levels including a range of geographical scales, wherein a lower bound of the range of geographical scales of each respective one of the plurality of sequential display levels is greater than an upper bound of the range of geographical scales of a sequentially previous one of the plurality of sequential display levels, and wherein an upper bound of the range of geographical scales of each respective one of the plurality of sequential display levels is less than a lower bound of the range of geographical scales of a sequentially next one of the plurality of sequential display levels;
determining a current display level as one of the plurality of sequential display levels that includes the displayed geographical scale;
receiving an indication of user input to modify the displayed geographical scale of the displayed georeferenced map;
determining, based on the received indication of the user input to modify the displayed geographical scale, a modified geographical scale of the displayed georeferenced map;
wherein outputting the one or more display attributes of each of the event icons associated with the two or more of the plurality of events that satisfy the threshold grouping criteria that cause the two or more of the plurality of events to be displayed on the georeferenced map as an event group icon comprises outputting the one or more display attributes that cause the two or more of the plurality of events to be displayed on the georeferenced map as an event group icon in response to determining that the modified geographical scale is included in the current display level.

20. A system comprising:
a computing device comprising at least one processor; and
computer-readable memory encoded with instructions that, when executed by the at least one processor, cause the computing device to:
receive data for an event having a geographical location, the data including information indicative of a popularity of the event;
determine, based on the information indicative of the popularity of the event, a popularity score for the event; and
output one or more display attributes of an event icon associated with the event that cause the event icon to be displayed on a georeferenced map of a geographical area including the geographical location of the event, at least one of the one or more display attributes corresponding to the determined popularity score for the event.
